(19) United States
(12) Patent Application Publication
(10) Pub. No.: US 2007/0000515 A1
(43) Pub. Date: Jan. 4, 2007

(54) Autofloss with floss winding mechanism

(76) Inventor: Jong-Fong Yang, Taoyuan city (TW)

Correspondence Address: Connolly Bove Lodge & Hutz, LLP, P.O. Box 2207, Wilmington, DE, 19899-2207, US

(21) Appl. No.: 11/474,927

(22) Filed: Jun. 26, 2006

(30) Foreign Application Priority Data
Jul. 1, 2005 (TW) 094122354

(51) Int. Cl. A61C 15/00

(52) U.S. Cl. 132/322

(57) ABSTRACT

An autofloss with a floss winding mechanism comprises a base seat and floss seat. A floss winding mechanism is accepted in a receiving room of the base seat; the floss winding mechanism is used for winding floss when it is driven by a rotating motor and the wound floss can be pulled out by a user's hand when the rotating motor is not rotated. A floss tightening stand is installed in a groove located in front of the receiving room of the base seat and a battery room for accepting batteries used for supplying the floss winding power to the rotating motor and the floss oscillating power to an eccentric motor installed in the floss seat. The floss seat is fixed to the base seat and a forklike Y-typed floss stick is disposed at the front end thereof. Through holes are respectively opened at two top ends of a fork disposed at the frond end of the floss stick, furthermore, the eccentric motor is installed inside the floss seat. Whereby, a better tartar cleaning and money saving autofloss can be attained.

### BACKGROUND OF THE INVENTION

1. Field of the Invention

The present invention relates to an autofloss, and more particularly to an autofloss installed with a floss winding mechanism and strengthening the oscillation of floss.

2. Description of Related Art

Please refer to FIG. 1. A conventional autofloss 1 is provided with a disposable Y-typed stick 2 with floss fixed thereon and a base seat 4 connected with the Y-typed stick 3. An eccentric motor 5 with an eccentric mass 8 mounted on the spindle thereof installed in the base seat 4 is used for oscillating the floss 2. Furthermore, a battery 6 for supplying the power of the motor can be filled in the base seat 4 and a button switch 7 for starting or stopping the rotation of the motor is also disposed thereon. When the autofloss 1 is used for cleaning a slit between teeth, locate the floss 2 in the slit and then turn on the switch 7, tartar between teeth can be cleaned by rotating the motor 5 to drive the eccentric mass 8 to rotate to oscillate the floss 2. The Y-typed stick 3 of the autofloss 1 is consumable, namely it is disposable and very expansive so that it is not only of no environmental consciousness but also of no economic benefits. Moreover, because the motor 5 is hid in the base seat 6, the oscillation thereof is absorbed by the base seat 6, the power transmitted to the Y-typed stick is unavoidably reduced so that the oscillation effect of the floss is not well enough, the slit cleaning effect is bad and the power of the battery is consumed.

### SUMMARY OF THE INVENTION

The main object of the present invention is to provide an autofloss with a floss winding mechanism, provided with a floss winding apparatus capable of winding floss of a cheaper floss case; it is not only of economic benefits but also of environmental consciousness.

Another object of the present invention is to provide an autofloss with a floss winding mechanism, provided with a floss oscillating motor installed in a floss seat and not in a base seat; the oscillation of floss becomes larger so that slits between teeth cleaning effect is better.

Still another object of the present invention is to provide an autofloss with a floss winding mechanism, disposed with a fur scraping cover fixing mechanism on a floss seat thereof for being engaged with a fur scraping cover; such kind of fur scraping cover not only possesses a cover function but also can be used for scraping fur on a tongue.

Still another object of the present invention is to provide an autofloss with a floss winding mechanism, a floss tightening stand is tightly pressed and fixed by a spring, and floss mounted in the autofloss is also pulled tight at the same time so that the slit between teeth can be cleaned well,

For attaining to the object mentioned above, an autofloss with a floss winding mechanism according to the present invention comprises a base seat and floss seat. A floss winding mechanism is accepted in a receiving room of the base seat; the floss winding mechanism is used for winding floss when it is driven by a rotating motor and the wound floss can be pulled out by a user's hand when the rotating motor is not rotated. A floss tightening stand is installed in a groove located in front of the receiving room of the base seat and a battery room for accepting batteries used for supplying the floss winding power to the rotating motor and the floss oscillating power to an eccentric motor installed in the floss seat. The floss seat is fixed to the base seat and a forklike Y-typed floss stick is disposed at the front end thereof. Through holes are respectively opened at two top ends of a fork disposed at the frond end of the floss stick, furthermore, the eccentric motor is installed inside the floss seat.

### BRIEF DESCRIPTION OF THE DRAWINGS

The present invention can be more fully understood by reference to the following description and accompanying drawings, in which:

FIG. 1 is a schematic view of the structure of a conventional autofloss;

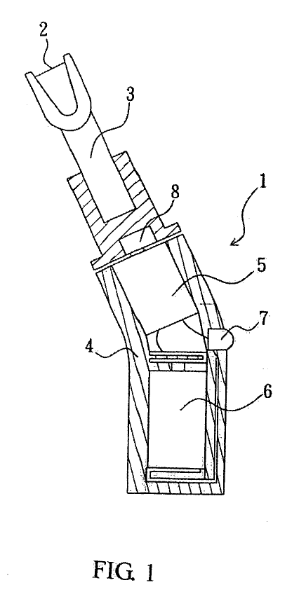

FIG. 2 is an exploded view, showing the structure of an autofloss with a floss winding mechanism of a preferred embodiment according to the present invention;

FIG. 3 is a partly cross sectional view, showing the combination structure of a floss winding mechanism of an autofloss with a floss winding mechanism of a preferred embodiment according to the present invention;

FIG. 4 is a partly cross sectional view, showing the combination state of a fur scraping cover and a floss seat of an autofloss with a floss winding mechanism of a preferred embodiment according to the present invention; and

FIG. 5 is a partly cross sectional view, showing the combination structure of a floss seat and a base seat of an autofloss with a floss winding mechanism of a preferred embodiment according to the present invention.

### DETAILED DESCRIPTION OF THE PREFERRED EMBODIMENTS

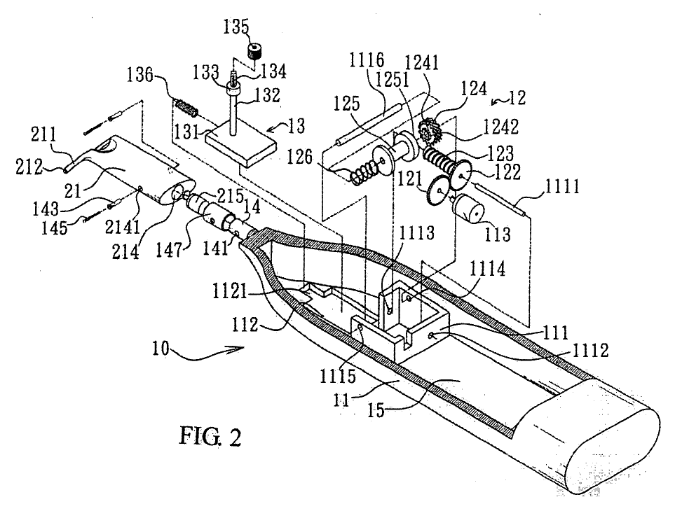

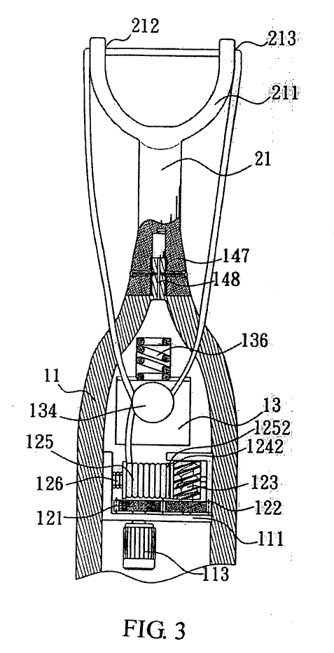

First, please refer to FIGS. 2 and 3. FIGS. 2 and 3 respectively are exploded and partly cross sectional views showing an autofloss with a floss winding mechanism of a preferred embodiment. An autofloss 10 is provided with an approximately long stripe shaped base seat 11 in which the front end thereof is shrunk to be neck-shaped and a thinner long floss seat 21. A receiving room 111 is disposed on the bottom of the base seat 11 close to the middle thereof and a battery room 15 is disposed at rear half part thereof; the receiving room 111 is used for accepting a floss winding mechanism 12 and the battery room 15 is used for accepting batteries. The floss winding mechanism 12 is constituted by two spur gears 121 and 122, a bolt 123 coaxial to the spur gear 122, a bevel gear 124 engaged with the bolt 123, a floss winding wheel 125 engaged with the bevel gear 124 and a spring 126 between the floss winding wheel 125 and the wall face of the receiving room 111. A rotating motor 113 used for driving the spur gear 121 is installed coaxially to the spur gear 121. Furthermore, a first supporting shaft 1111 is passed through the axle centers of the spur gear 122 and bolt 123 to fix them in two fixing holes 1112 and 1113 disposed in the longitudinal direction of the receiving room 111. Furthermore, ratchet disks (a disk with ratchets disposed thereon) 1242 and 1252 engaged with each other are respectively disposed on the surfaces of two corresponding face 1241 and 1251 respectively on the bevel gear 124 and the floss winding wheel 125, and a second supporting shaft 1115 is respectively passed the axle centers of the bevel gear 124 and the floss winding wheel 125 and the spring 126 to fix them in two fixing holes 1114 and 1115 disposed in the transverse direction of the receiving room 111. When the floss winding mechanism 12 is mounted in the receiving room 111, the rotating motor 113 is coaxial with the spur gear 121, the spur gear 121 and 122 are engaged with each other, the spur gear 122 is coaxial with the bolt 123, the bolt 123 and the bevel gear 124 are engaged with each other to form a deceleration mechanism, the bevel gear 124 and the floss winding wheel 125 are engaged with each other by means of the ratchets respectively disposed on them, the bevel gear 124 can drive the floss winding wheel 125 only in a single direction and cannot drive it in the opposite direction. The reason that the spring 126 is installed between the floss winding wheel 125 and the inner surface of the receiving room 111 is to prop the floss winding wheel 125 tightly against the bevel gear 124 to cause the ratchet disks 1241 and 1251 to be engaged with each other closely as FIG. 3 shows. When a user wants to wind floss, he turn on the rotating motor 113, the motor 113 drives the spur gear 121, the spur gear 122, the bolt 123, the bevel gear 124 and the floss winding wheel 125 to rotate. Because the ratchets on the bevel gear 123 can drive the ratchets on the floss winding wheel 125 to move in this direction, the floss can be wound around the floss winding wheel 125 at this time. When the floss is wound around the floss winding wheel 125 to a proper amount, the motor 113 can be turned off and the floss winding is stopped. If a user wants to draw the floss out, he can draw it out smoothly to a required length because the ratchets respectively disposed on the ratchet disks 1241 and 1251 do not interfere each other in this direction.

A groove 112 is disposed on the front end of the bottom of the base seat 11 and in front of the receiving room 11; the groove 112 is a rectangular groove in principle, but it has a recess 1121 close to the front edge of the base seat 11. A floss tightening stand 13 is accepted in the groove 112. The floss tightening stand 13 is constituted by a base plate 131 and an erective rod 132 in which the erective rod 132 is vertically fixed on the base plate 131 and the upper end thereof is combined with a fixing button 133. The part of the erective rod beyond the fixing button 133 is disposed with a bolt portion 134 used for being engaged with a movable button 135 with inner thread. The recess 131 can accept a spring 136 in which both ends thereof are respectively propped against the side face of the base plate 131 and the wall face of the recess 1121.

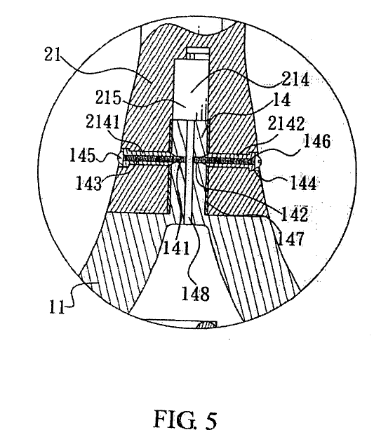

Please refer to FIGS. 2, 3 and 5. Among these, FIG. 5 is a cross sectional view showing the inner part at the combination place of a base seat and a floss seat. The front end of the floss seat 21 is a Y-shaped floss stick 211. Two ends of a fork of the floss stick 211 are respectively pierced through with through holes 212 and 213 for allowing floss to be passed through. A combination hole 214 is opened at the rear end of the floss seat 21 to combine with a combination mass 14 disposed at the front end of the base seat 11. Two opposite fixing holes 2141 and 2142 are disposed on the floss seat 21 at the circumference of the combination hole 214 and two fixing holes 141 and 142 are also disposed on the circumference of the combination mass 14. When a user wants to combine the floss seat 21 and the base seat 11 to form an autofloss, he first mounts an eccentric motor 215 with an eccentric mass into the combination hole 214, and then inserts the combination mass 14 into the combination hole 214 and passes a power cord of the eccentric motor 215 through a center hole 148 at the center of the combination mass 14 into the base seat 11. Furthermore, rubber covers 143 and 144 are respectively inserted into the fixing holes 2141 and 2142 and up to the fixing holes 141 and 142 after the fixing holes 2141 and 2142 are respectively aligned with the fixing holes 141 and 142. Finally, two screws 145 and 146 are respectively screwed into the rubber covers 143 and 144 so that the floss seat 21 and the base seat 11 can be combined together to form the integral autofloss 10.

When a user wants to mount floss onto the autofloss with a floss winding mechanism according to the present invention, he puts the head of floss in a floss case available in the market around a fixer (not shown in the figure) disposed on the floss winding wheel 125, turns on the rotating motor 113. The floss can be wound around the floss winding wheel 125 through the rotations of the spur gear 121 and 122, the bolt 123, the bevel gear 124 and the floss winding wheel 125. The user can turn off the motor 113 when a proper amount of the floss is obtained.

When a user wants to use the autofloss 10, please refer to FIG. 3, he can draw the floss out of the floss winding wheel 125 smoothly because the ratchet disk mechanism does not hinder the rotation of the floss winding wheel 125 in this reverse direction. The drawn-out floss is first wound one circle around the bolt part 134 of the floss tightening stand 13 and then passed through the through holes 212 and 213 disposed at the front end of the floss seat 21. Thereafter, the user exerts a force slightly on the head of the floss when it is wound around the bolt part 134 between the fixing button 133 and the movable button 135 disposed on the floss tightening stand 13 and the base plate 131 will be moved forward in the groove 112 to prop against the spring 136 tightly at this time. After that, the movable button 135 is revolved tight to fix the head of the floss. Finally, the user moves his hand away from the floss tightening stand 13, the spring 136 will naturally press the floss tightening stand backward to cause the floss to be stretched tight. At this time, the autofloss 10 can be used to clean slits between teeth.

Please refer to FIG. 5 again. What is to be particularly stressed here is: the reason that the rubber covers 143 and 144 are inserted into the combination holes 2141, 2142, 141 and 142 according to the present invention mainly is to allow the oscillation generated from the eccentric motor 215 to be remained in the floss seat 21 as far as possible and not to be diffused into the base seat 11. Therefore, the oscillation of the floss seat 21 is reinforced so that the slit cleaning effect is better. Moreover, a gap held between the wall face of the combination hole 214 and the outer surface of the combination mass 14 (i.e. a loose fit between both of them) can be design for the assembled autofloss 10 according to the present invention. Thereby, the oscillation of the floss seat 21 is more difficult to be transmitted into the base seat 11. Otherwise, a transparent silicon bush 147 is installed between the wall face of the combination 214 and the outer surface of the combination mass 14. Thereby, the oscillation of the floss seat 21 is more difficult to be transmitted into the base seat 11 and the waterproof function can be attained.

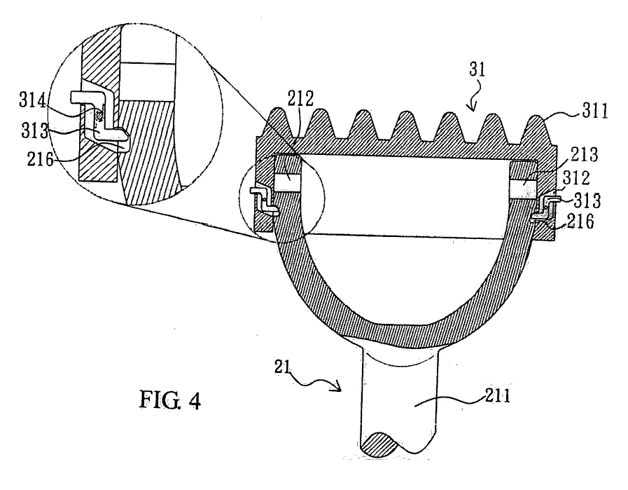

Please refer to FIG. 4. A seizing hole 216 used for fixing a fur scraping cover 31 is close to each fork end disposed on the floss stick 211 of the floss seat 21. Serrate lines 311 are disposed on the fur scraping cover 31 and two receiving rooms 312 corresponding to the seizing holes 216 are respectively disposed on both sides of the fur scraping cover 31. An engaging stick 313 that is controlled to rotate by a torsion spring 314 is installed in the receiving room 312. When the fur scraping cover 31 is mounted onto the front end of the floss seat 21, the engaging sticks 313 can then respectively be seized into the seizing holes 216. Thereby, the autofloss 10 mounted with the fur scraping cover 31 can then be used as a fur scraper. Furthermore, when a user wants to take off the fur scraping cover 31, he only needs to use two fingers to press the engaging sticks 313; the fur scraping cover 31 can then be taken off smoothly.

The autofloss with a floss winding mechanism according to the present invention has the following effects and merits from the description mentioned above:
1. because the autofloss according to the present invention has a floss winding mechanism, it does not need to be mounted with an expensive disposable floss stick of a conventional autofloss and only needs a general floss case available in the market so that it is money saving and convenient.
2. the oscillation can be isolated from the base seat and strengthened in the floss seat to be contributive to the cleaning of tartar between teeth, because the oscillation isolating mechanism is installed at the combination place of the floss seat and the base seat of the autofloss according to the present invention.
3. a fur scraping cover can be mounted on the autofloss according to the present invention so that both of the tartar cleaning and the fur scraping functions can be attained; the autofloss is a utensil with dual purpose other than a general conventional autofloss.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An autofloss with a floss winding mechanism, comprising:
a base seat, comprising:
a floss winding mechanism in a receiving room thereof, used for winding floss while being driven by a rotating motor, said wound floss being allowed to draw out when said rotating motor is not rotated;
a floss tightening stand, installed in a groove disposed in front of said receiving room of said base seat; and
a battery room, used for accepting batteries to supply the floss winding power of said floss winding mechanism and the oscillation power of said autofloss; and
a floss seat, combined with said base seat, a Y-shaped floss stick being disposed at the front end thereof, two through holes being respectively disposed in two fork ends thereof and an eccentric motor being accepted therein;
Whereby, said wound floss is passed through said floss passing holes at the front ends of said floss stick and then fixed on and drawn tight by said floss tightening stand after said floss is drawn out from said floss winding mechanism.

2. The autofloss according to claim 1, wherein said floss winding mechanism is constituted by two spur gears, a deceleration mechanism, a floss winding wheel and a motor; one of said spur gears is connected to a power outputting shaft of said motor and engaged with said another spur gear, the axle center of said another spur gear is further connected to said deceleration mechanism, said deceleration mechanism is engaged with said floss winding wheel through a ratchet mechanism driving in a single direction to allow said motor to drive floss winding wheel to rotate in said single direction.

3. The autofloss according to claim 2, wherein said deceleration mechanism is constituted by a bolt and a bevel gear engaged therewith.

4. The autofloss according to claim 3, wherein said ratchet mechanism is constituted by two ratchet disks engaged with each other and disposed respectively on the sides of said bevel gear and said floss winding wheel facing to each other.

5. The autofloss according to claim 4, further comprising a spring installed at another side of said floss winding wheel to press said ratchet disks to engaged with each other tightly.

6. The autofloss according to claim 1, wherein said floss tightening seat has a base plate, an erective rod is installed thereon, a fixing button is installed at the upper end of said erective rod, threads are disposed on said erective rod beyond said fixing button, said threads is used for engaged with a movable button to fix said floss and a spring is used for propping against the front side of said base plate.

7. The autofloss according to claim 1, wherein a combination mass at the front end of said base seat is inserted into a combination hole of said floss seat to combine said base seat with said floss sea and screws are used for fixing said base seat and said floss seat together.

8. The autofloss according to claim 7, wherein said each screw is covered with a rubber cover and said rubber cover is extended into said combination mass.

9. The autofloss according to claims 7 or 8, wherein a gap exists between said combination mass and said combination hole or a transparent silicon bush is inserted between said combination mass and said combination hole.

10. The autofloss according to claim 9, wherein said eccentric motor is installed in said combination hole and in front of said combination mass.

11. The autofloss according to claim 1, wherein two fixation structures are respectively disposed on two sides of said Y-shaped floss seat to fix a fur scraping cover with lines.

12. The autofloss according to claim 11, wherein said fixation structure is a seizing hole.

13. The autofloss according to claim 12, wherein an engaging stick controlled by a torsion spring and corresponding to each said seizing hole is installed in said fur scraping cover.

14. The autofloss according to claim 1, wherein a floss cutting mechanism used for cutting said used floss is disposed on a upper cover of said base seat.
